(19) United States
(12) Patent Application Publication
(10) Pub. No.: US 2013/0073811 A1
(43) Pub. Date: Mar. 21, 2013

(54) REGION PRIVATIZATION IN DIRECTORY-BASED CACHE COHERENCE

(71) Applicants: Bradford M. Beckmann, Redmond, WA (US); Arkaprava Basu, Madison, WI (US); Steven K. Reinhardt, Vancouver, WA (US)

(72) Inventors: Bradford M. Beckmann, Redmond, WA (US); Arkaprava Basu, Madison, WI (US); Steven K. Reinhardt, Vancouver, WA (US)

(73) Assignee: ADVANCED MICRO DEVICES, INC., Sunnyvale, CA (US)

(21) Appl. No.: 13/234,855

(22) Filed: Sep. 16, 2011

(51) Int. Cl. G06F 12/08

(52) U.S. Cl. 711/141; 711/E12.026

(57) ABSTRACT

A system and method for region privatization in a directory-based cache coherence system is disclosed. The system and method includes receiving a request from a requesting node for at least one block in a region, allocating a new entry for the region based on the request for the block, requesting from the memory controller the data for the region be sent to the requesting node, receiving a subsequent request for a block within the region, determining that any blocks of the region that are cached are also cached at the requesting node, and privatizing the region at the requesting node.

### FIELD OF INVENTION

This application is related to directory-based cache coherence and specifically to region privatization in directory-based cache coherence.

### BACKGROUND

Conventional cache algorithms maintain coherence at the granularity of cache blocks. However, as cache sizes have become larger, the efficacy of these cache algorithms has decreased. Inefficiencies have been created both by storing information and data block by block, and by accessing and controlling on the block level.

Solutions for this decreased efficacy have included attempts to provide macro-level cache policies by exploiting coherence information of larger regions. These larger regions may include a contiguous set of cache blocks in physical address space, for example. These solutions have allowed for the storage of control information at the region level instead of storing control information on a block by block basis, thereby decreasing the storage and access necessary for the control information.

Attempts have been made to opportunistically maintain coherence at a granularity larger than a block size—typically 64 bytes. These attempts are generally designed to save unnecessary bandwidth. Specifically, these attempts either incorporate additional structures that track coherence across multiple cache block sized regions or merge both region and individual cache block information into a single structure. When the region-level information indicates that no other caches cache a particular region, the snoops associated with certain requests may be deemed unnecessary, thus saving bandwidth.

For example, region coherence may be extended, such as using Virtual Tree Coherence, in a hybrid directory/snooping protocol where the directory assigned regions to multicast trees. Requests may be utilized within the tree to maintain coherence. Specifically, Virtual Tree Coherence may utilize region tracking structure and only track sharing information at the region level. Thus cache blocks within shared regions may not be assigned individual owners, and marked sharers for a region level must respond to all requests with that region.

Directory-based cache-coherent multiprocessor systems use a global directory to track the coherence state of individual cache blocks. Requests from individual processor cores or caches consult the directory entry corresponding to the requested cache block to determine where the up-to-date copy of the cache block resides, such as in memory or in another cache, for example, and which other caches, if any, may need to be involved in the coherence transaction, including to invalidate other sharers before providing a writable copy to a requesting cache.

### SUMMARY OF EMBODIMENTS

A system and method for region privatization in a directory-based cache coherence system are disclosed. The system and method may receive a request from a requesting node for at least one block in a region, allocate a new entry for the region based on the request for the block, request from the memory controller the data for the region be sent to the requesting node, receive a subsequent request for a block within the region, determine that any blocks of the region that are cached are also cached at the requesting node, and privatize the region at the requesting node. The home node may receive the request from a requesting node for the at least one block in the region. The home node may be based on the address of the region. The new entry may be allocated at the requesting node. The request from the memory controller may be made by the home node. The determining may be performed by the home node. The subsequent request may be a second or third, or some greater number of request for a block within the region.

The system and method may include determining that the region is not cached in the directory of the home node. The system and method may include requesting blocks in the region directly from the main memory. Such a request may be performed by the requesting node.

The system and method for privatizing at least one region in a directory-based cache coherence system may include a home node determined based on the address of the at least one region, a requesting node communicatively coupled to the home node and requesting access to data of the at least one region, the requesting node requesting data from the home node, and main memory storing the data of the at least one region and responding to requests from at least one of the home node and the requesting node by providing data from the at least one region. The home node may determine that the at least one region is not cached in the directory of the home and may privatize the at least one region at the requesting node to thereby allow the requesting node to request data from the at least one region directly from the main memory. The requesting access to data of the at least one region is the second request by the requesting node for data from the at least one region.

### BRIEF DESCRIPTION OF THE DRAWING(S)

Understanding of the present invention will be facilitated by consideration of the following detailed description of the preferred embodiments of the present invention taken in conjunction with the accompanying drawings, in which like numerals refer to like parts:

FIG. 1 shows a computer system including the interface of the central processing unit, main memory, and cache;

FIG. 2 illustrates a multiple cache structure sharing resources;

FIG. 3 illustrates a baseline architectural design of a core processor using directory protocols;

FIG. 4 illustrates an operation of a directory coherence protocol;

FIG. 5 illustrates a region directory coherence protocol;

FIG. 6 illustrates an example of a region directory coherence protocol; and

FIG. 7 illustrates a method for region privatization in a directory-based cache coherence system.

### DETAILED DESCRIPTION OF THE PREFERRED EMBODIMENT(S)

Embodiments of the invention may rely on a directory storage structure, which may be organized to track sharing behavior both on individual cache blocks and on contiguous aligned regions of, for example, 1 KB to 4 KB in size. According to embodiments of the present invention and given region-level coherence tracking, the home node may identify when the cached copies within a particular region are cached only at a single common node. When that single caching node is a node other than the home node, then the home node may transfer ownership of the region to the caching node. This transferring of ownership of the region to the accessing node is referred to as “privatizing.” After privatization, the caching node may access other blocks within the region by going directly to the off-chip main memory without going through the original static home node. Additionally, blocks that are displaced from the L1 and L2 caches within the accessing node may be cached in the L3 bank that is local to the accessing node rather than being sent to the original static home node.

The invention may allow a distributed caching system to provide higher performance and lower power consumption when some fraction of the data accessed by each core or cluster of cores is accessed by that core/cluster for a significant period of time. This situation may be found when a multicore system is used to run a collection of workloads, such as a multi-programmed scenario, or when it is used to run a collection of virtual machines, such as a VM consolidation scenario, where each workload or VM occupies only a single core or only a subset of cores co-located within a cluster.

A system and method for region privatization in a directory-based cache coherence system is disclosed. The system and method may receive a request from a requesting node for at least one block in a region, allocate a new entry for the region based on the request for the block, request from the memory controller the data for the region be sent to the requesting node, receive a subsequent request for a block within the region, determine that any blocks of the region that are cached are also cached at the requesting node, and privatize the region at the requesting node. The home node may receive the request from a requesting node for the at least one block in the region. The home node may be based on the address of the region. The new entry may be allocated at the requesting node. The request from the memory controller may be made by the home node. The determining may be performed by the home node. The subsequent request may be a second or third, or some greater number of request for a block within the region;

The system and method may include determining that the region is not cached in the directory of the home node. The system and method may include requesting blocks in the region directly from the main memory. Such a request may be performed by the requesting node.

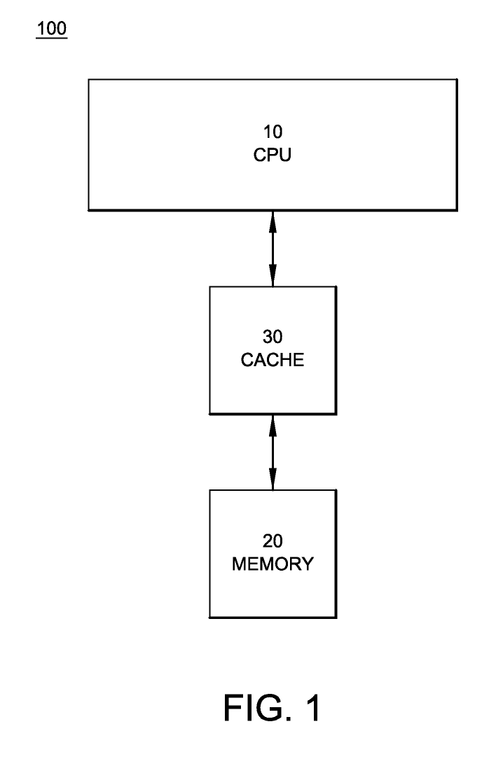

FIG. 1 shows a computer system 100 including the interface of the central processing unit (CPU) 10, main memory 20, and cache 30. CPU 10 may be the portion of computer system 100 that carries out the instructions of a computer program, and may be the primary element carrying out the functions of the computer. CPU 10 may carry out each instruction of the program in sequence, to perform the basic arithmetical, logical, and input/output operations of the system.

Suitable processors for CPU 10 include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Typically, CPU 10 receives instructions and data from a read-only memory (ROM), a random access memory (RAM), and/or a storage device. Storage devices suitable for embodying computer program instructions and data include all forms of non-volatile memory, including by way of example, semiconductor memory devices, magnetic media such as internal hard disks and removable disks, magneto-optical media, and optical media such as CD-ROM disks and DVDs. Examples of computer-readable storage mediums also may include a register and cache memory. In addition, the functions within the illustrative embodiments may alternatively be embodied in part or in whole using hardware components such as ASICs, FPGAs, or other hardware, or in some combination of hardware components and software components.

Main memory 20 (also referred to as primary storage, internal memory, and memory) may be the memory directly accessible by CPU 10. CPU 10 may continuously read instructions stored in memory 20 and may execute these instructions as required. Any data may be stored in memory 20 generally in a uniform manner. Main memory 20 may comprise a variety of devices that store the instructions and data required for operation of computer system 100. Main memory 20 may be the central resource of CPU 10 and may dynamically allocate users, programs, and processes. Main memory 20 may store data and programs that are to be executed by CPU 10 and may be directly accessible to CPU 10. These programs and data may be transferred to CPU 10 for execution, and therefore the execution time and efficiency of the computer system 100 is dependent upon both the transfer time and speed of access of the programs and data in main memory 20.

In order to increase the transfer time and speed of access beyond that achievable using memory 20 alone, computer system 100 may use a cache 30. Cache 30 may provide programs and data to CPU 10 without the need to access memory 20. Cache 30 may take advantage of the fact that programs and data are generally referenced in localized patterns. Because of these localized patterns, cache 30 may be used as a type of memory that may hold the active blocks of code or data. Cache 30 may be viewed for simplicity as a buffer memory for main memory 20. Cache 30 may not interface directly with main memory 20, although cache 30 may use information stored in main memory 20. Indirect interactions between cache 30 and main memory 20 may be under the direction of CPU 10.

While cache 30 is available for storage, cache 30 may be more limited than memory 20, most notably by being a smaller size. As such, cache algorithms may be needed to determine which information and data is stored within cache 30. Cache algorithms may run on or under the guidance of CPU 10. When cache 30 is full, a decision may be made as to which items to discard to make room for new ones. This decision is governed by one or more cache algorithms.

Cache algorithms may be followed to manage information stored on cache 30. For example, when cache 30 is full, the algorithm may choose which items to discard to make room for the new ones. In the past, as set forth above, cache algorithms often operated on the block level so that decisions to discard information occurred on a block by block basis and the underlying algorithms developed in order to effectively manipulate blocks in this way. As cache sizes have increased and the speed for access is greater than ever before, cache decisions may be examined by combining blocks into regions and acting on the region level instead.

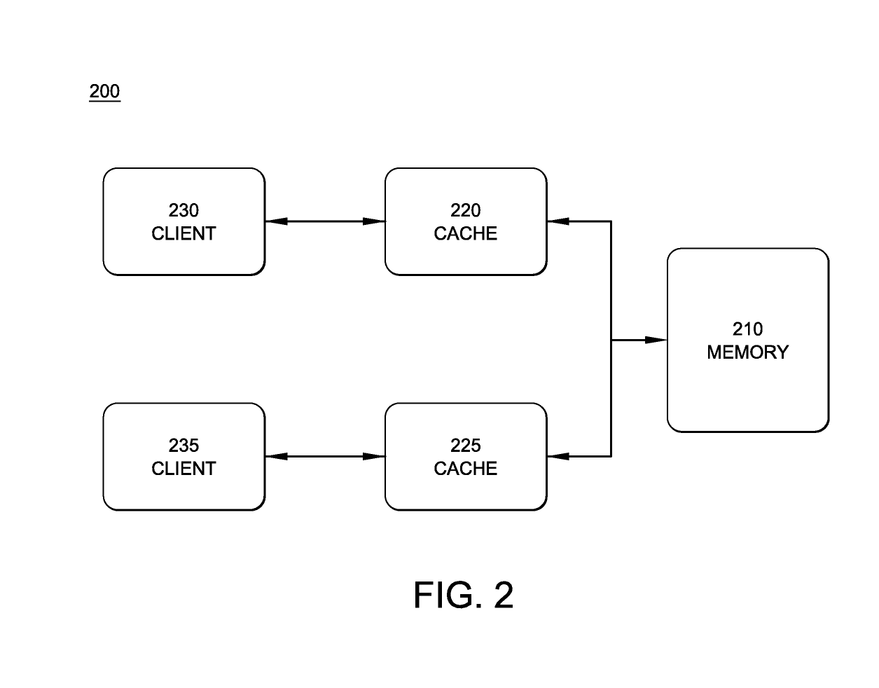

In computing, cache coherence refers to the consistency of data stored in local caches of a shared resource. When clients in a system maintain caches of a common memory resource, problems may arise with inconsistent data. This is particularly true of CPUs in a multi-processor system. Referring to FIG. 2 there is illustrated a multiple cache structure 200 sharing resources. Multiple cache structure 200 may include a memory resource 210, a first cache 220, a second cache 225, a first client 230, and a second client 235. Caches 220, 225 may each be coupled to memory resource 210 having therein a plurality of memory blocks. Client 230 may be coupled to cache 220, and client 235 may be coupled to cache 225. In this example, if client 230 has a copy of a memory block from a previous read of memory resource 210 and client 235 changes that memory block, client 230 may be left with an invalid cache of memory without any notification of the change. Cache coherence is intended to manage this type of conflict and maintain consistency between cache and memory.

Coherence may define the behavior associated with reading and writing to a memory location. The following non-limiting examples of cache coherence are provided, and are provided for discussion.

Coherence may be maintained if a processor reads a memory location, following writing to the same location, with no other processors writing to the memory location between the write and read by the processor, when that memory location returns the value previously written by the processor. That is, that which is last written is returned.

Coherence may also be maintained if a second processor reads a memory location after a first processor writes to that memory location, with no processors writing to the memory location between the read and write, when that memory location returns the value previously written by the first processor. That is, the value that was last written is returned.

Coherence may also be maintained if writes to a memory location are sequenced. That is, if a memory location receives two different values, in order, by any two processors, a processor may never read the memory location as the second value and then read it as the first value, but instead must read the memory location with the first value and the second value in order.

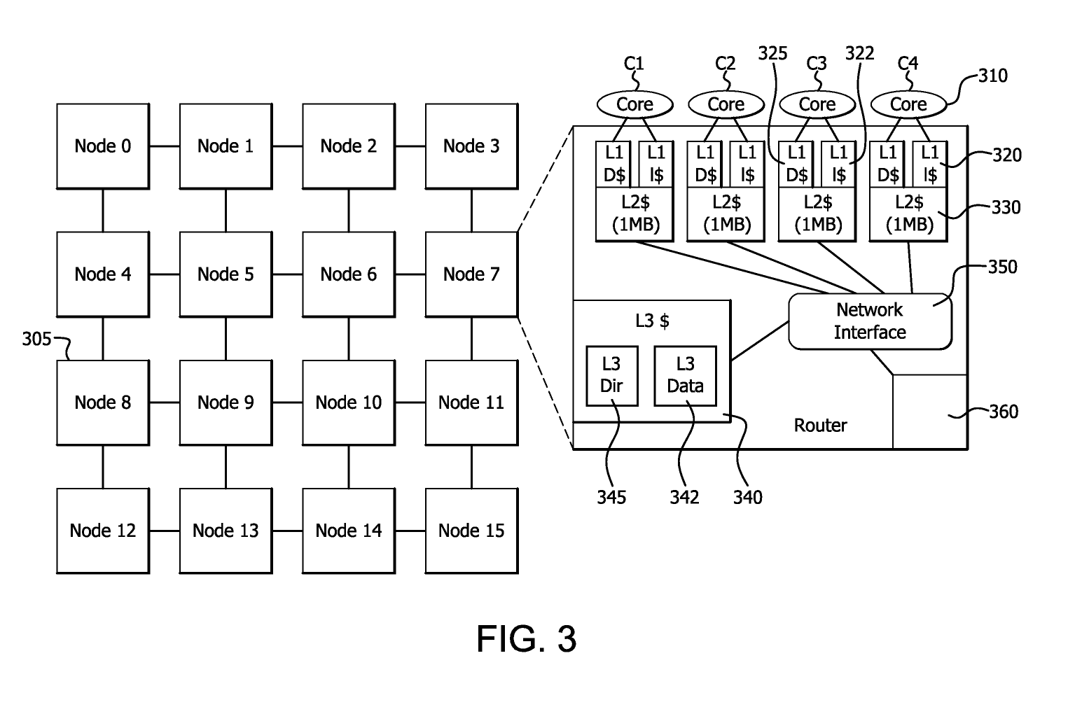

FIG. 3 is baseline architectural design of a core processor using directory protocols. Shown in FIG. 3 are sixteen nodes (identified as Node 0, Node 1, . . . , Node 15) 305. Node 7 is shown in an exploded view in FIG. 3. Each node may have a plurality of cores 310 although four are shown in FIG. 3 as C1, C2, C3 and C4 as an example, there may be more or less cores 310. The cores 310 may have associated therewith a level 1 (L1) or primary cache 320, often the fastest type of cache, and may be located on the processor. L1 cache 320 may be split into two caches of equal size—one may be used to store program data, shown as L1 D$ 325, and another may be used to store microprocessor instructions, shown as L1 I$ 322. A unified L1 cache 320 may be used to store both data and instructions in the same cache (not shown).

Core 310 may also have a level 2 (L2) secondary cache 330. Generally, L2 cache 330 is larger than L1 320 and located between the processor and memory. A level 3 (L3) cache 340 may also be present and may be located between the processor and memory. Generally, L3 340 is slower and larger than L2 330. As shown in FIG. 3, L3 cache 340 may be sectioned into discrete parts including directory 345 and data 342, for example. As shown in FIG. 3, while L1 320 and L2 330 caches may be unique to core 310, such as C1, for example, L3 cache 340 may be shared by some or all of the plurality of cores 310 within a node. In FIG. 3, L3 cache 340 may be shared by cores C1, C2, C3, C4. As shown, FIG. 3 has 16 nodes, 64 cores, 128 L1 caches, 64 L2 caches, and 16 L3 caches. Maintaining coherence of these 208 caches requires a proper balance of storage overhead and bandwidth demand.

Directory cache coherence protocols may be scalable solutions to maintain data coherency for large multiprocessor systems. Directory protocols may achieve better scalability than snooping protocols because directory protocols may dynamically track the sharers of individual cache lines and may not broadcast to find the current sharers when the protocol necessitates intervention. As core and cache counts continue to scale, broadcast-based snooping protocols may encounter even greater scalability challenges because both the total number of broadcasts and the number of destinations per broadcast increase. Thus, directory protocols may provide an on-chip cache coherence solution for many-core processors such as is illustrated in FIG. 3.

While directory protocols demand significantly less bandwidth than snooping protocols, directory protocols may require extra metadata storage to track the current sharers. The exact amount of storage information required by the directory protocol may depend on the particular details of the protocol. For example, SGI Origin's directory protocol maintains cache block sharing information on a per node basis for systems that are 64 nodes or smaller. Each node in such a system may be represented by a separate bit in a bit vector, and thus, the directory requires 64 bits of storage for each cache line in the system. To support systems with greater than 64 nodes, the SGI Origin protocol may group nodes into groups and represent each unique group of nodes as a separate bit in the bit-vector. When operating in this coarse-grain bit-vector mode, nodes within a group may be searched when the bit vector indicates that at least one sharer exists within the group of nodes. Similarly, to clear the bit within the coarse-grain bit vector, nodes within the group may be consulted and coordinated to ensure that there are no sharers of the block.

In contrast to SGI Origin's directory protocol that tracks sharing information in a bit-vector, AMD's probe filter directory protocol may track a single sharer that is identified as the owner of the cache block. The owner may be the particular node responsible for responding to requests when one or more caches store the cache line. Using the full cache coherence protocol MOESI, which is a full cache coherency protocol that encompasses all of the possible states commonly used in other protocols, by way of an example, the owner may be the cache that has the block in M, O or E state. Without involving other caches, cache blocks in one of these three owner states may directly respond to all read requests, and when in M or E state may also directly respond to write requests. These directed request-response transactions may be referred to as “directed probes.” By storing only the owner information, the probe filter directory protocol may save significant storage as compared to other bit-vector solutions. For example, in a 64-node system, the owner may be encoded in 6 bits, while the bit-vector requires 64 bits, leading to a 10× reduction in metadata storage. However, the cost of only storing the owner may necessitate a broadcast to potential sharers for certain operations, where the bit-vector solution only needs to multicast to the current sharers. Assuming the probe filter directory is located at the L3 cache and is inclusive with respect to the L1 and L2 caches, while the L3 data cache is non-inclusive with respect to the L1 and L2 caches, several specific probe filter operations may require broadcasts. These operations include write operations where more than one sharer exists; read or write operations where the owner data block has been replaced, but L1/L2 sharers still exist; and invalidation operations to maintain probe filter inclusion when a probe filter entry must be replaced for a cache block that at one time was shared by multiple cores.

Directory-based cache-coherent multiprocessor systems may use a global directory to track the coherence state of individual cache blocks. Requests from individual processor cores or caches may consult the directory entry corresponding to the requested cache block to determine where the up-to-date copy of the cache block resides, such as in memory or in another cache, for example. The directory may be consulted as to which other caches, if any, may need to be involved in the coherence transaction, such as, for example, to invalidate other sharers before providing a writable copy to a requesting cache.

Directory storage may be associated with an L3 cache, and may be associated 1:1 with a DRAM memory controller. The directory at a given node may track the state of cache blocks that are normally stored in the DRAM attached to the associated memory controller. That node is considered the “home” node for those blocks. In a multi-node, multi-socket, or multi-die system, the home node may be determined from a block's physical address. Requests may be forwarded to the home node regardless of the node originating the request. If a request forwarded to the home node finds that the block contents in DRAM are up to date, that is if the block is not cached elsewhere in the system, then the contents may be fetched from the local DRAM and returned to the requester without visiting any other nodes.

As core counts increase, a single die may be subdivided into multiple nodes 305; each with one or more cores 310, a portion of a global L3 cache 340, and a portion of the directory 345, as illustrated in FIG. 3. In this design, the “home node” for a cache block may be determined by the block's physical address. The L3 cache 340 structures at each node 305 may combine to form a unified global L3, where each local L3 340 portion caches only the blocks for which that node is the home. That is, the global L3 may be formed from address-interleaved banks distributed across the nodes 305. The directory 345 portion of the node may track the cache status for its home blocks to enforce coherence among the L1 cache 320 and L2 cache 330, which can hold blocks from any home node. The directory 345 may be collocated with the portion of the global L3 cache associated with the cache block address and not with the associated memory controller or DRAM. This may accelerate where the data is found in the global L3 cache slice and may provide more coherence throughput given that the number of nodes 305 may be much larger than the number of memory controllers.

Decoupling the directory location from the memory controller may require an additional message to request data from the memory controller when the block is not cached in the home node L3 340 or elsewhere on chip. The global address interleaving of the L3 cache 340 may leave data cached in a portion of the L3 that is distant from the node 305 accessing that data even when there is only one node from which it is accessed.

The region privatization in directory-based cache coherence described herein may minimize or even eliminate many of the additional indirections through the home node and the additional L3 access latency by dynamically detecting regions accessed by only one node and temporarily effectively relocating the home node to the accessing node. For example, associating the directory with the memory controller rather than the relevant L3 cache slice may minimize or eliminate latency. By associating the directory with the memory controller, additional latency may be created when the data is found in the L3 cache, as an additional message to the home L3 node may be required. Further, by example, the L3 cache may be kept near the memory controllers rather than distributed along with the cores. In such a configuration, the L3 may be uniformly distant from all cores. Further, the distributed L3 cache may be treated as independent caches, so that each node may cache data from any address in its local L3. This independence may reduce the effective L3 capacity of the system, as copies of the same data block may be cached in multiple nodes, forcing other blocks to be evicted and increasing the number of accesses that must go to DRAM.

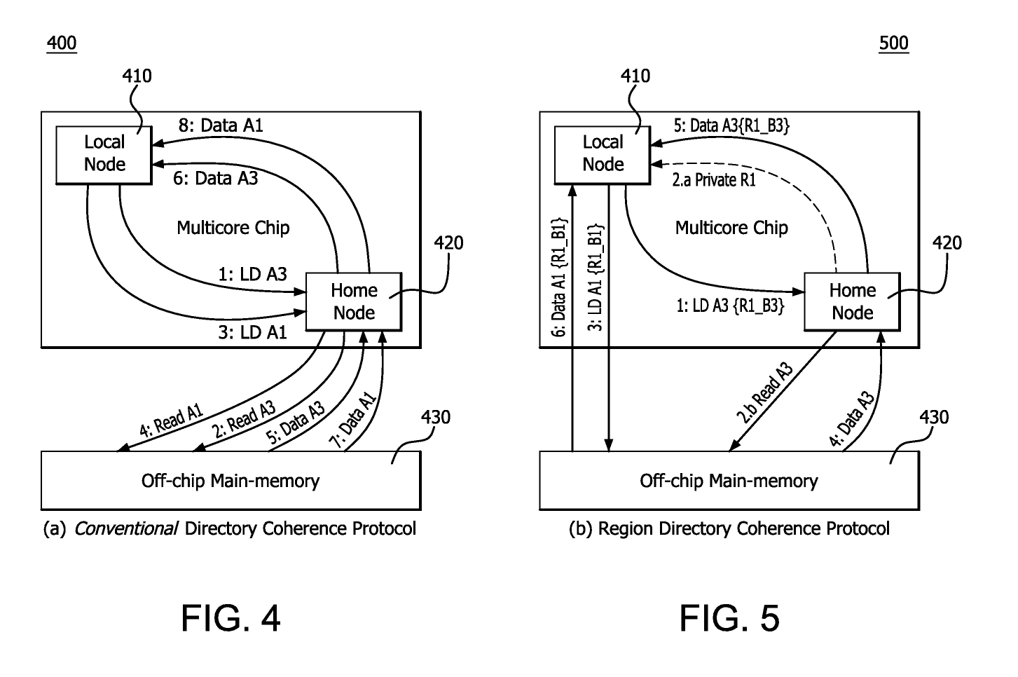

Referring now to FIG. 4, there is illustrated an operation of a directory coherence protocol 400. In this example, a local node 410 may need copies of blocks A1 and A3. As shown in FIG. 4, local node 410 may request block A3 from home node 420 at step 1. Responsive to this request, home node 420 may read block A3 from off-chip memory 430 at step 2. Local node 410 may request block A1 from home node 420 at step 3. Responsive to this request, home node 420 may read block A1 from off-chip memory 430 at step 4. Responsive to home node 420 reading block A3, A3 data may be transferred from off-chip memory 430 to home node 420 at step 5. Home node 420 may transfer data A3 to local node 410 at step 6. Responsive to home node 420 reading block A1, A1 data may be transferred from off-chip memory 430 to home node 420 at step 7. Home node 420 may transfer data A1 to local node 410 at step 8. Local node 410 may have copies of blocks A1 and A3.

Referring now to FIG. 5, there is illustrated a region directory coherence protocol 500. In this example, local node 410 may need copies of A1 and A3. As shown in FIG. 5, local node 410 may request block A3 (R1:B3) from home node 420 at step 1. Responsive to this request, home node 420 may read block A3 from off-chip memory 430 at step 2b and may privatize R1 to local node 410 at step 2a. Now that R1 is privatized to local node 410, a subsequent request for block A1 (R1:B1) may be made directly from local node 410 to off-chip memory 430 at step 3. Responsive to home node 420 reading block A3, A3 data may be transferred from off-chip memory 430 to home node 420 at step 4. Home node 420 may transfer data A3 to local node 410 at step 5. Responsive to the privatization of local node 410 and local node 410 requesting block A1 directly from off-chip memory, A1 data may be transferred from off-chip memory 430 to local node 410 at step 6.

While privatization may optimize performance for blocks that are not shared among cores, or are only shared among the cores in a single node, privatization may not remove the region from the coherence protocol. If another node requests a block within the privatized region, that request may go to the static home node, at which point the home node may revoke the privatization, inform the original accessing node, and revert management of the region back to the standard state in which the home node is responsible for maintaining coherence.

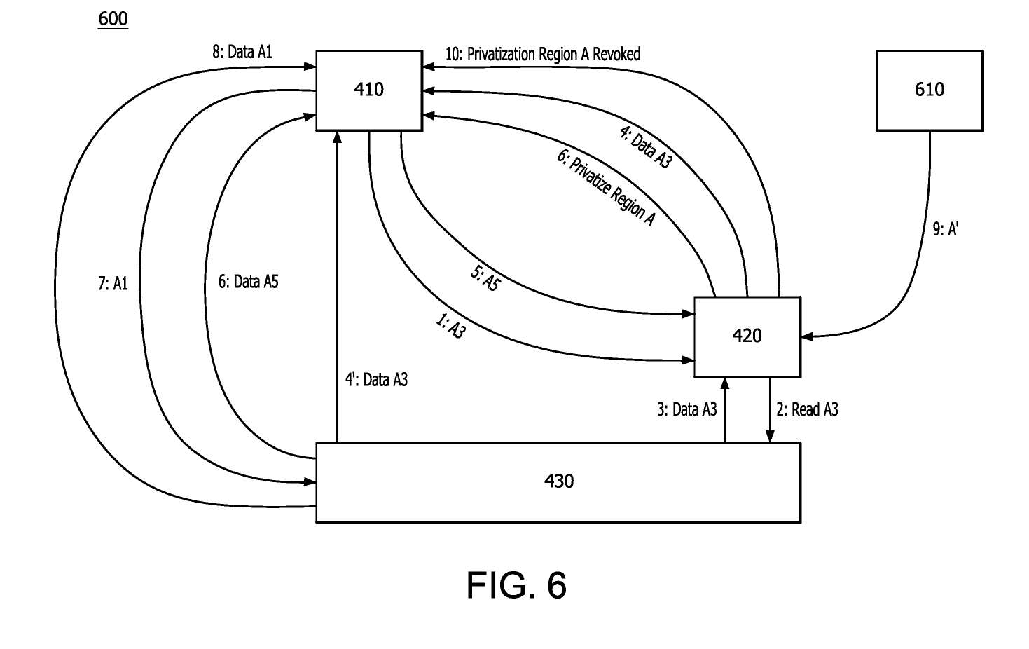

Referring now to FIG. 6, there is illustrated another example 600 of a region directory coherence protocol. Assume that region A consists of blocks A1, A2, A3, . . . An, and home node 420 is the home node for region A. A core on local node 410 may reference block A3. A3 is not found in any cache or in the directory on local node 410, so home node 420 may be determined based on the address of region A. When the request for A3 arrives at home node 420 at step 1, the region may be looked up in the directory of home node 420, and no corresponding entry may be found. A new entry for region A may be allocated, and block A3 may be marked as being cached at local node 410. A request may be forwarded to off-chip memory 430 for region A at step 3, requesting that the data for block A3 be fetched and sent to local node 410 at step 3. Local node 410 may receive responses from home node 420 and/or off-chip memory 430 and may load block A3 into its L1 and/or L2 caches at step 4. Subsequently, a core on local node 410 may reference block A5. This request may be sent to home node 420 at step 5, which finds that only one block in region A is cached, and that that block A3 is cached by local node 410. The coherence controller on home node 420 may decide to privatize region A to local node 410 at step 6. The coherence controller may record this decision in the directory entry for region A, may notify local node 410, and may request block A5 from off-chip memory 430 to be sent to local node 410 at step 6. Upon receiving notice of privatization, local node 410 may allocate an entry in its own local directory to mark region A as private. Subsequently, a core on local node 410 references block A1. Now local node 410 finds that region A is marked as private in its directory, so local node 410 may send a request for block A1 directly to off-chip memory 430, bypassing home node 420 at step 7. Other blocks from region A, including re-references to blocks A3 and A5, if they get evicted from the cache, may be fetched by local node 410 directly from off-chip memory 430. Blocks from region A that are evicted from the L1 and L2 caches in local node 410 may be cached in a local L3 bank of local node 410, because local node 410 knows that these blocks may not be replicated in the L3 bank at home node 420 where they would normally be stored.

If a new node 610 requests a block in region A, this request may be directed to home node 420 at step 9. When home node 420 detects a request from node 610 to a region that has been privatized to local node 410, home node 420 may notify local node 410 that the privatization has been revoked at step 10. Local node 410 may remove any cached blocks from region A from its L3 cache, though it may keep blocks cached in its L1 or L2, and coherence control and L3 caching of region A may revert to home node 420.

Other implementations may differ in details, such as a region may be privatized immediately on the first access, or privatization may be deferred until the home node sees three unique blocks from the same region being requested by the same node, for example.

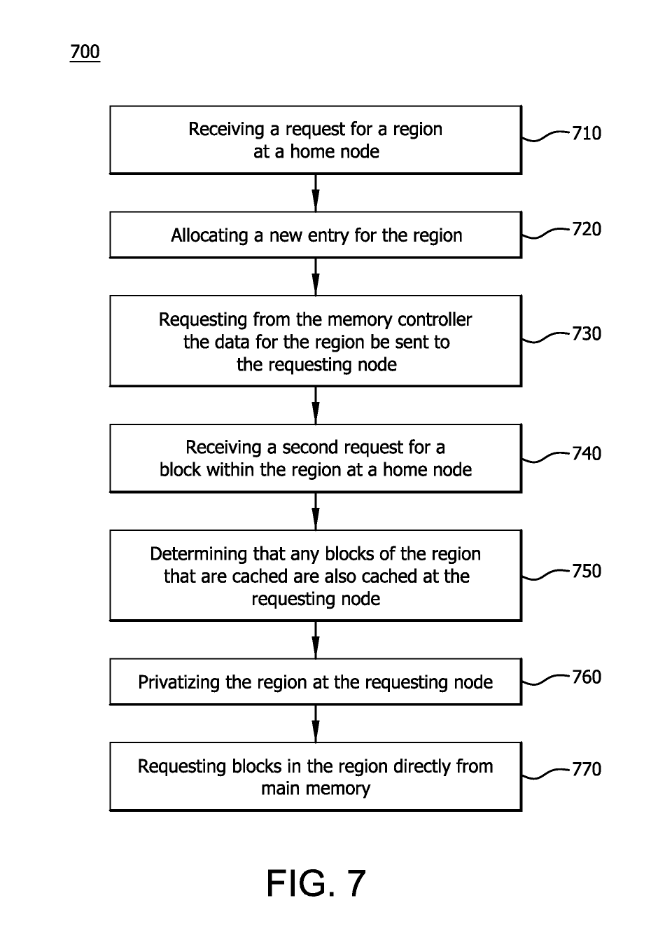

Referring now to FIG. 7, there is illustrated a method 700 for region privatization in a directory-based cache coherence system. Method 700 may include receiving a request for at least one block in a region at step 710. This request may be received at a home node. The home node may be based on the address of the region. Method 700 may include determining that the region is not cached in the home node's directory.

Method 700 may include allocating a new entry for the region based on the request for the block at step 720. This new entry may be at the requesting node. Method 700 may include requesting from the memory controller the data for the block be sent to the requesting node at step 730. The request at step 730 may be made by the home node.

Method 700 may include receiving a second request for a block within the region at the home node at step 740 and determining that any blocks of the region that are cached are also cached at the requesting node at step 750. This determination may be made by the home node.

Method 700 may include privatizing the region at the requesting node at step 760 and requesting blocks in the region directly from the main memory at step 770. The request 770 of blocks directly from the main memory may be made by the requesting node.

The present invention may be implemented in a computer program tangibly embodied in a computer-readable storage medium containing a set of instructions for execution by a processor or a general purpose computer. Method steps may be performed by a processor executing a program of instructions by operating on input data and generating output data.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

While specific embodiments of the present invention have been shown and described, many modifications and variations could be made by one skilled in the art without departing from the scope of the invention. The above description serves to illustrate and not limit the particular invention in any way.

What is claimed is:

1. A method for region privatization in a directory-based cache coherence system, said method comprising:
receiving a request from a requesting node for at least one block in a region;
allocating a new entry for the region based on the request for the block;
requesting from the memory controller the data for the block be sent to the requesting node;
receiving a subsequent request for a block within the region;
determining that any blocks of the region that are cached are also cached at the requesting node; and
privatizing the region at the requesting node.

2. The method of claim 1 wherein said received request is received at a home node, said home node based on the address of the region.

3. The method of claim 2 further comprising determining that the region is not cached in the directory of the home node.

4. The method of claim 1 wherein the new entry is allocated at the requesting node.

5. The method of claim 1 wherein the request from the memory controller is made by the home node.

6. The method of claim 1 wherein the receiving a second request for a block within the region is at the home node.

7. The method of claim 1 further comprising requesting blocks in the region directly from the main memory.

8. The method of claim 7 wherein the requesting of blocks is made by the requesting node.

9. The method of claim 1 wherein the subsequent request is a second request for a block within the region;

10. The method of claim 1 wherein the subsequent request is a third request for a block within the region.

11. A method for region privatization in a directory-based cache coherence system, said method comprising:
receiving a request from a requesting node for at least one block in a region; and
privatizing the region at the requesting node.

12. The method of claim 11 further comprising requesting from the memory controller that the data for the region be sent to the requesting node.

13. The method of claim 11 further comprising determining that any blocks of the region that are cached are also cached at the requesting node.

14. The method of claim 11 further comprising determining that the region is not cached in the directory of the home node.

15. The method of claim 11 further comprising requesting blocks in the region directly from the main memory.

16. The method of claim 15 wherein the requesting of blocks is made by the requesting node.

17. A system for privatizing at least one region in a directory-based cache coherence system, said system comprising:
a home node determined based on the address of the at least one region;
a requesting node communicatively coupled to said home node and requesting access to data of the at least one region, said requesting node requesting data from said home node; and
main memory storing the data of the at least one region and responding to requests from at least one of said home node and said requesting node by providing data from the at least one region,
wherein said home node determines that the at least one region is not cached in the directory of the home and privatizes the at least one region at said requesting node thereby allowing said requesting node to request data from the at least one region directly from the main memory.

18. The system of claim 17 wherein the requesting access to data of the at least one region is the second request by said requesting node for data from the at least one region.

19. A computer readable medium including hardware design code stored thereon which when executed by a processor cause the system to perform a method for region privatization in a directory-based cache coherence system, said method comprising:
receiving a request from a requesting node for at least one block in a region;
allocating a new entry for the region based on the request for the block;
requesting from the memory controller the data for the block be sent to the requesting node;
receiving a subsequent request for a block within the region;
determining that any blocks of the region that are cached are also cached at the requesting node; and
privatizing the region at the requesting node.

20. The computer readable medium of claim 19 further comprising determining that the region is not cached in the directory of the home node receiving said received request.

21. The computer readable medium of claim 19 wherein the receiving a second request for a block within the region is at the home node.

22. The computer readable medium of claim 19 further comprising requesting blocks in the region directly from the main memory.

23. The computer readable medium of claim 22 wherein the requesting of blocks is made by the requesting node.

24. The computer readable medium of claim 19 wherein the subsequent request is a second request for a block within the region;

25. The computer readable medium of claim 19 wherein the subsequent request is a third request for a block within the region.
